(19) United States
(12) Patent Application Publication
(10) Pub. No.: US 2026/0176914 A1
(43) Pub. Date: Jun. 25, 2026

(54) APPARATUS AND ASSOCIATED METHODS FOR REMOVING AT LEAST ONE PORTION OF AT LEAST ONE COATING SYSTEM PRESENT IN A MULTI-GLAZED WINDOW MOUNTED ON A STATIONARY OR MOBILE OBJECT

(71) Applicant: AGC GLASS EUROPE, Louvain-la-Neuve (BE)

(72) Inventor: Eric MORGANTE, Gosselies (BE)

(73) Assignee: AGC GLASS EUROPE, Louvain-la-Neuve (BE)

(21) Appl. No.: 19/127,624

(22) PCT Filed: Nov. 30, 2023
(86) PCT No.: PCT/EP2023/083827

§ 371 Date: May 6, 2025

(30) Foreign Application Priority Data
Dec. 2, 2022 (EP) 22211042.1

(51) Int. Cl. E06B 3/67; E06B 9/24

(52) U.S. Cl. CPC E06B 3/6715; E06B 9/24; E06B 2009/2405

(57) ABSTRACT

An apparatus for removing at least one portion of at least one coating system present in a multi-glazed window, the window including at least two glass panels alternatively separated by at least one interlayer and forming multiple interfaces. The apparatus includes an horizontal system having an horizontal bar and at least one suction means to detachably fix the apparatus in front of the multi-glazed window. The apparatus further includes a decoating unit which includes a decoating device including a laser source that generates a laser beam and a first motor. The horizontal system also includes a straight-toothed rack and a rail slider. The apparatus further includes a shuttle sliding along the rail slider; the decoating unit being attached to the horizontal bar by the slider element, the decoating unit further including a pinion wheel driven by the first motor and running on the straight-toothed rack.

### DESCRIPTION

### Technical Field

The present invention relates to an apparatus for removing at least one portion of at least one coating system present in a multi-glazed window in general and, more specifically, an apparatus for removing at least one portion of at least one coating system present in a multi-glazed window already mounted on a stationary object, for instance a building, or mounted on a mobile object, for instance a vehicle, a train.

The invention is preferably used to modify the electromagnetic properties of a multi-glazed window already mounted on a stationary object, for instance a building, or mounted on a mobile object, for instance a vehicle, a train. This modification is achieved by partially decoating a coating system on one of the interfaces of the glass panels forming the multi-glazed window.

The present invention also relates to associated methods and uses.

Thus, the invention concerns multiple domains where multi-glazed windows including at least one coating system are used and wherein removing part of said coating system is required to optimize the transmission and/or the reception of an antenna system through a window.

### BACKGROUND ART

A standard single-layered window has poor thermal performances. This is why most windows are now built using two or more glass panels separated by a gas and/or polymer-based interlayer. This kind of windows are is called a multi-glazed window.

A coating system is typically applied on the interface of one or several glass panels of a multi-glazed window in order to further improve the multi-glazed window properties.

This coating system can either improve the multi-glazed window insulation, reduce the amount of infrared and/or ultraviolet radiation entering the multi-glazed window and/or keep the sun's heat out of a space wherein such multi-glazed window insulation is used.

However, this type of coating systems is generally metal-based and therefore acts as a Faraday cage, preventing electromagnetic waves such as radio waves, from entering or leaving the space.

In order to improve the transmittance of a multi-glazed window containing a coating system, one can use a laser decoating system to remove at least one portion of the coating system. The total surface to be decoated is typically between 1 and 3% of the total coating system surface, in order to both improve the transmission of radio waves through the multi-glazed-window without impairing the properties of said coating system.

Preferably, to improve the transmission of a radio wave through the window, the decoating system will remove segments from the coating system and the sum of the longest sub-segment of each segment is equal to nλ/2 wherein n is a positive integer greater than zero and lambda (λ) is the wavelength of the radio wave. It is necessary to have a wide band frequency selective surface in order to ensure the transmission of waves of different frequencies through the multi-glazed window, typically between 2 GHz and 100 Ghz. For instance, the decoating system can be configured to remove a segment of a length greater than 400 mm and a width between 10 and 100 μm.

Preferably, for some applications such as toll communication systems, 4G and/or 5G receptors and transmitters, a small decoating portion is desired instead of a large decoating portion. For instance, a small decoating portion has typically a length less than 400 mm.

A simple approach to solve this problem of RF energy reflection is to completely remove a surface of the coating system. This approach, however, reduces the solar control benefits offered by the multi-glazed window due to the absence of the coating system in such surface. Moreover, for multi-glazed window located inside the building, the vehicle or the car, the decoated surface would be unacceptably large. On top of that, the transition between the decoated portion and the coating itself is eye-visible and usually non-accepted by users.

Another solution has been to remove a portion made of cut lines in the coating system to create a surface which is frequency selective: it has relatively high reflectivity/absorbance for solar energy but relatively low reflectivity/absorbance in the RF region of the electromagnetic spectrum. The cutting may be performed by laser ablation and the spacing of the slits is chosen to provide selectivity at the desired frequency.

To improve the transmittance of said multi-glazed window, WO 20200/050762 describes an apparatus comprising a laser light source and a lens array configured to focus said laser light source on a coating system of a multi-glazed window. Said apparatus is mounted on suction pads to secure said apparatus on said multi-glazed window. Said apparatus also comprises at least two motors configured to move said laser along rails along the X and Y axis. Said laser is capable of scribing a grid shape on said coating system to improve the electromagnetic transmission of said multi-glazed window.

However, said laser is always focused on the internal surface of the second glass panel in the multi-glazed window. In fact, this apparatus is only calibrated for a single type of double-glazed window being two glass panels separated by a spacer creating a space filled with gas, where the coating system is positioned on the internal interface of the window. Hence, it is not possible to use this apparatus to other types of windows where the glass thickness is different or where the coating system is applied on a different interface.

In another domain, U.S. Pat. No. 6,559,411 describes an apparatus for laser scribing a tin oxide layer coated on a glass panel substrate.

A predetermined scribing is formed on the tin oxide layer by focusing a laser on said tin oxide layer and by displacing said glass panel substrate by a conveyor along the X or Y axis. Moreover, the position of the laser is adjusted in the Z direction during the laser scribing to maintain the focusing on said tin oxide layer.

However, this focusing requires a precise and complete understanding of the glass panel substrate including the thickness of each layer and the position of said tin oxide layer as well as the knowledge of the exact distance between the conveyor and the laser.

Laser beam of prior art is always placed and fixed orthogonally to the surface to be decoated. To create a decoated surface the decoating device must be displace along said surface using motors and complex drive systems.

Moreover, systems described in prior art are heavy to mount on a multi-glazed window due to displacement elements (structure, . . . ) and motors.

Thus, this apparatus can only be used in factories on glass panel that have just been manufactured. Hence, this apparatus cannot be used on a multi-glazed window of unknown structure, such as the number of glass panels, the number of lamination layers, the numbers of spacers, the number, nature and position of the coating system, . . . and that is already mounted on an object, for instance a building or a vehicle.

In addition, a large number of windows are already installed and are known to prevent the transmission of electromagnetic wave. Such windows cannot be replaced or be replaced without important costs. The multi-glazed windows cannot be retrieved from the object, sent back to a factory to remove the part of the coating and then, sent back to be assembled again on the object. Such situations require the decoating process to be carried out in situ, when the multi-glazed window is mounted on the object. In most cases, the structure of these multi-glazed windows and the exact position of their coating system is completely unknown. It is therefore impossible for such apparatus to focus the laser properly on the coating system.

Apparatus of the prior art, especially X-Y apparatus, are heavy, more than 40 kg, and then at least two operators are needed to handle such apparatus. On top of that, because of their assembly, dimensions are fixed then such apparatus cannot be used for a wide range of windows. Treatable windows are limited to larger windows than dimensions of such apparatus. Then, when different sizes of windows have to be treated, several apparatus are needed. This is also the case when the surface to treat is larger than the size of the apparatus. On top of that, with such apparatus is not possible to treat 100% of the surface of the window due to fixation system on said window.

On top of that, in a building, in a train or alike, a large amount of windows needs to be treated to remove a portion to enhance the signal inside the building, the train or alike. It means that the decoating treatment has to be done on multiple windows in different environments such as offices, meeting rooms, laboratories, cargo cars, passenger cars, . . . and it is a need to have an ease of handling for operators. Apparatus of the prior art are heavy and cannot be easily handle to change from a window to another window. Operators cannot handles too heavy components and are not able to install said system in the right manner.

### SUMMARY OF INVENTION

The present invention relates, in a first aspect, to an apparatus for removing at least one portion of at least one coating system present in a multi-glazed window comprising at least two glass panels alternatively separated by at least one interlayer and forming multiple interfaces.

The apparatus comprises an horizontal system. The horizontal system comprises an horizontal bar and at least one suction means and a decoating unit.

The at least one suction means is configured to detachably fix said configured to detachably fix said apparatus in front of said multi-glazed window, preferably said suction means comprises a vacuum pad or a suction cup; said means being firmly fixed to the horizontal bar.

The decoating unit comprises a decoating device including a laser source that generates a laser beam and a first motor designed to displace the decoating device along a plane P substantially parallel to the multi-glazed window.

The solution as defined in the first aspect of the present invention is based on that the horizontal system further comprises a straight-toothed rack and a rail slider configured to displace the decoating unit along the horizontal bar.

The solution as defined in the first aspect of the present invention is also based on that the apparatus comprises a shuttle sliding along the rail slider. The decoating unit is attached to the horizontal bar by the slider element. Preferably, the decoating unit is suspended from the slider element to facilitate the handling.

The solution as defined in the first aspect of the present invention is also based on that the decoating unit further comprises a pinion wheel driven by the first motor and running on the straight-toothed rack.

The present invention relates, in a second aspect, to a method for removing at least one portion of at least one coating system present in a multi-glazed window with an apparatus according the first aspect of the invention.

The method of the second aspect comprises the following steps:
A1.Providing the horizontal system;
A2.Mounting the horizontal bar on an external interface of said multi-glazed window or on a surface next to the multi-glazed window with the suction means;
A3.Providing the decoating unit;
A4.Mounting the decoating unit on the shuttle;
A5.Providing the decoating device;
A6.Mounting the decoating device on the decoating unit;
A7.Removing a first portion of said coating system with said decoating device.

The present invention relates, in a third aspect, to a method for removing at least one portion of at least one coating system present in a second multi-glazed window with an apparatus according the first aspect of the invention.

The method of the third aspect comprises the following steps:
B1. Unmounting the decoating device of the decoating unit from the apparatus mounted on an external interface of a first multi-glazed window;
B2. Storing the decoating device;
B3. Unmounting the decoating unit from the shuttle;
B4. Storing the decoating unit;
B5. Unmounting the horizontal bar from the external interface of the first multi-glazed window;
B6. Mounting the horizontal bar on an external interface of the second multi-glazed window with the suction means;
B7. Mounting the decoating unit on the shuttle;
B8. Mounting the decoating device on the decoating unit;
B9. Removing a first portion of said coating system with said decoating device.

The present invention permits to decoat several windows with an easy handling.

The present invention relates, in a fourth aspect, to an use of the apparatus according the first aspect of the invention to remove at least one portion of at least one coating system present in a multi-glazed window wherein said multi-glazed window is mounted on a stationary object or on a mobile object.

The present invention allows easily and fast removing at least a portion of at least one coating system present in a multi-glazed window mounted on a stationary object or on a mobile object to modify the electromagnetic properties of a multi-glazed window already mounted on a stationary object, for instance a building, or mounted on a mobile object, for instance a vehicle, a train.

Compared to the prior art, especially X-Y apparatus, the present invention also allows a single operator to handle the apparatus thanks to the innovative assembly while using a better ergonomic for the operator.

On top of that, the present invention also allows to an user inside the stationary object or the mobile object to have a better EM reception and transmission.

Therefore, the present invention allows to reduce the power needed to transmit and receipt EM waves such as mobile data. This allows to reduce health risk.

It is noted that the invention relates to all possible combinations of features recited in the claims or in the described embodiments.

The following description relates to building applications but it's understood that the invention may be applicable to others fields like automotive or transportation applications.

### BRIEF DESCRIPTION OF THE DRAWINGS

This and other aspects of the present invention will now be described in more detail, with reference to the appended drawings showing various exemplifying embodiments of the invention which are provided by way of illustration and not of limitation. The drawings are a schematic representation and not true to scale. The drawings do not restrict the invention in any way. More advantages will be explained with examples.

FIG. 1 is a schematic view of an apparatus, according to the first aspect of the invention, mounted on a multi-glazed window.

FIG. 2 is a schematic sectional view according to plan AA′ of the apparatus mounted on a multi-glazed window of FIG. 1.

FIG. 3 is a schematic view of an apparatus, according to the first aspect of the invention, mounted on a multi-glazed window.

FIG. 4 is a schematic sectional view according to plan BB′ of the apparatus mounted on a multi-glazed window of FIG. 3.

FIG. 5 is a schematic view of steps of the method according to the second aspect of the present invention.

FIG. 6 is a schematic view of steps of the method according to the third aspect of the present invention.

FIG. 7 is an schematic 3D view of a part of an horizontal bar with a suction means configured to detachably fix said horizontal bar substantially horizontally to said multi-glazed window of an apparatus according to the first aspect of the invention.

FIG. 8 is an schematic 3D view of a decoating unit of an apparatus according to the first aspect of the invention.

FIG. 9 is an schematic 3D view of the upper part of a decoating unit of an apparatus according to the first aspect of the invention.

FIG. 10 is an schematic 3D view of the upper part of a decoating unit of an apparatus according to the first aspect of the invention during the step of mounting on a shuffle of an apparatus according to the second and/or third aspect of the present invention.

FIG. 11 is an schematic 3D view of a decoating device and a device support according to the first aspect of the invention.

### DETAILED DESCRIPTION

In this document to a specific embodiment and include various changes, equivalents, and/or replacements of a corresponding embodiment. The same reference numbers are used throughout the drawings to refer to the same or like parts.

As used herein, spatial or directional terms, such as “inner”, “outer”, “above”, “below”, “top”, “bottom”, and the like, relate to the invention as it is shown in the drawing figures. However, it is to be understood that the invention can assume various alternative orientations and, accordingly, such terms are not to be considered as limiting. Further, all numbers expressing dimensions, physical characteristics, processing parameters, quantities of ingredients, reaction conditions, and the like, used in the specification and claims are to be understood as being modified in all instances by the term “about”. Accordingly, unless indicated to the contrary, the numerical values set forth in the following specification and claims are approximations that can vary depending upon the desired properties sought to be obtained by the present invention. In the following description, unless otherwise specified, expression “substantially” mean to within 10%, preferably to within 5%.

Moreover, all ranges disclosed herein are to be understood to be inclusive of the beginning and ending range values and to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10. Further, as used herein, the terms “deposited over” or “provided over” mean deposited or provided on but not necessarily in surface contact with. For example, a coating “deposited over” a substrate does not preclude the presence of one or more other coating films of the same or different composition located between the deposited coating and the substrate.

Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated. In this document, “configured to (or set to)” may be interchangeably used in hardware and software with, for example, “appropriate to”, “having a capability to”, “changed to”, “made to”, “capable of”, or “designed to” according to a situation. In any situation, an expression “device configured to do” may mean that the device “can do” together with another device or component.

Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein. When it is described that a constituent element (e.g., a first constituent element) is “(functionally or communicatively) coupled to” or is “connected to” another constituent element (e.g., a second constituent element), it should be understood that the constituent element may be directly connected to the another constituent element or may be connected to the another constituent element through another constituent element (e.g., a third constituent element).

It is an object of the present invention to alleviate the above described problems and to improve the electromagnetic transmission of a multi-glazed window. Especially, the object of the present invention is to improve the speed of the decoating process, the precision properties of the apparatus that can be used on multi-glazed windows mounted in situ.

Another advantage of the present invention is to minimize risk of damage of a coating system on a multi-glazed window to be decoated.

This and other aspects of the present invention will now be described in more details, with reference to the appended drawings showing various exemplifying embodiments of the invention which are provided by way of illustration and not of limitation. The drawings are a schematic representation and not true to scale. The drawings do not restrict the invention in any way. More advantages will be explained with examples.

For a better understanding, the scale of each member in the drawing may be different from the actual scale. In the present specification, a three-dimensional orthogonal coordinate system in three axial directions (X axis direction, Y axis direction, Z axis direction) is used, the longitudinal direction of the multi-glazed window is defined as the X direction, the transversal direction is defined as the Y direction, and the height is defined as the Z direction. The displacement of the apparatus versus the multi-glazed window is achieved within the Z direction. The narrowing of the distance between the apparatus and the multi-glazed window is defined as the +Y axis direction, and increasing the distance is achieved the opposite direction and is defined as the −Y axis direction.

According to the first aspect of the invention, the invention relates to an improved apparatus for removing at least one portion of at least one coating system present in a multi-glazed window comprising at least two glass panels alternatively separated by at least one interlayer and forming multiple interfaces.

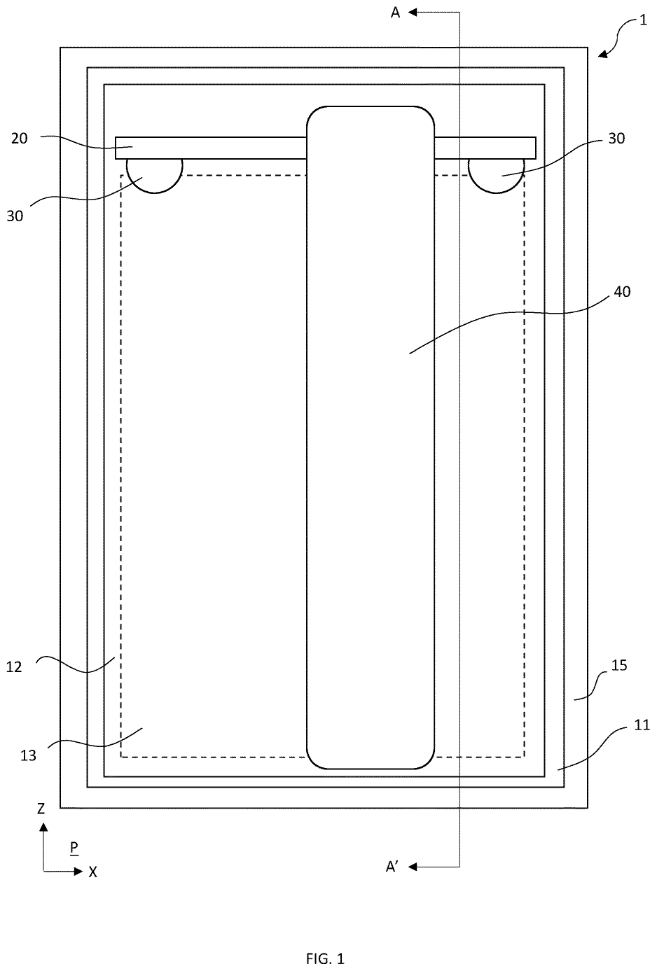

FIG. 1 illustrates an embodiment where an apparatus 1 comprising an horizontal bar 20, a suction means 30 comprising two suctions pads, and a decoating unit 40. The apparatus is placed in front of a multi-glazed window 11 comprising a coating 12. The multi-glazed window is mounted on an object 15. The decoating can be made on a maximum decoatable area 13. It is understood that the decoating unit can partially decoat a smaller area than the maximum decoatable area.

### Multi-Glazed Window

The multi-glazed window is mounted in situ meaning already mounted on a stationary object, for instance building, or on a mobile object, for instance a vehicle, a train.

The invention allows to very fast remove a portion of a coating system, for instance to improve the electromagnetic transmission, of a multi-glazed window while easily handle such apparatus. All the more so, if at least a portion of a coating system need to be remove from a plurality of multi-glazed windows.

Thus, the apparatus of the invention can be used to improve the electromagnetic properties of a (a plurality of) multi-glazed window(s) mounted in situ and improve the communication, the transmission and the reception of EM waves, of the object where the multi-glazed windows are mounted on in a very fast way.

The multi-glazed window can be a multi-glazed window used as a window to close an opening of the stationary object or to close an opening of the mobile object.

Said multi-glazed window, extends along a plane Pw, defined by a longitudinal axis X and a vertical axis Z, and has interfaces substantially parallel to plane Pw. The multi-glazed window has a thickness measured along the Y-axis.

The multi-glazed window can be at least partially transparent to visible waves for visibility, and natural or artificial light. The multi-glazed window is made of multiple panels separated by at least one interlayer, forming multiple interfaces. The panels therefore can be separated by a space filled with gas or by a polymeric interlayer.

In some embodiments, the multi-glazed window can comprise at least two glass panels separated by a spacer allowing to create a space filled by a gas like Argon to improve the thermal isolation of the multi-glazed window, creating an insulating multi-glazed window. The invention is not limited to apparatus for use on multi-glazed window having two panels. The apparatus and method of the present invention are suitable for any multi-glazed window such as double, triple glazed windows.

In another embodiments, the glass panel can be a laminated multi-glazed window such as those to reduce the noise and/or to ensure the penetration safety. The laminated glazing comprises panels maintained by one or more interlayers positioned between glass panels. The interlayers are typically polyvinyl butyral (PVB) or ethylene-vinyl acetate (EVA) for which the stiffness can be tuned. These interlayers keep the glass panels bonded together even when broken in such a way that they prevent the glass from breaking up into large sharp pieces.

Said panels of the multi-glazed window can be made of glass, polycarbonate, PVC or any other material used for a window mounted on a stationary object or on a mobile object.

Usually, the material of the panels of multi-glazed window is, for example, soda-lime silica glass, borosilicate glass, aluminosilicate glass or other materials such as thermoplastic polymers or polycarbonates which are especially known for automotive applications. References to glass throughout this application should not be regarded as limiting.

The multi-glazed window can be manufactured by a known manufacturing method such as a float method, a fusion method, a redraw method, a press molding method, or a pulling method. As a manufacturing method of the multi-glazed window, from the viewpoint of productivity and cost, it is preferable to use the float method.

Each panel can be independently processed and/or colored, . . . and/or have different thickness in order to improve the aesthetic, thermal insulation performances, safety, . . . . The thickness of the multi-glazed window is set according to requirements of applications.

The multi-glazed window can be any known window used in situ. For example, the multi-glazed window can be processed, ie annealed, tempered, . . . to respect the specifications of security and anti-thief requirements. The window can independently be a clear glass or a colored glass, tinted with a specific composition of the glass or by applying an additional coating or a plastic layer for example. The window can have any shape to fit to the opening such as a rectangular shape, in a plan view by using a known cutting method. As a method of cutting the multi-glazed window, for example, a method in which laser light is irradiated on the surface of the multi-glazed window to cut the multi-glazed window, or a method in which a cutter wheel is mechanically cutting can be used. The multi-glazed window can have any shape in order to fit with the application, for example a windshield, a sidelite, a sunroof of an automotive, a lateral glazing of a train, a window of a building, . . . .

Figures show a generic rectangular shape of the multi-glazed window. Rectangle includes not only a rectangle or a square but also a shape obtained by chamfering corners of a rectangle or a square. The shape of the multi-glazed window in a plan view is not limited to a rectangle and may be a trapeze, especially for a windshield or a backlite of a vehicle, a triangle, especially for a sidelight of a vehicle, a circle or the like.

In addition, the multi-glazed window can be assembled within a frame or be mounted in a double skin façade, in a carbody, in a trainbody or any other means able to maintain a multi-glazed window. Some plastics elements can be fixed on the multi-glazed window to ensure the tightness to gas and/or liquid, to ensure the fixation of the multi-glazed window or to add external element to the multi-glazed window. In some embodiments, a masking element, such as an enamel layer, can be added on part of the periphery of the multi-glazed window.

The multi-glazed window can be flat or curved according to requirements by known methods such as hot or cold bending. In case of curved multi-glazed window, plane Pw is defined locally by X- and Z-axis substantially tangential to the surface and in the whole surface of the window by three axis, X-, Y- and Z-axis.

It is understood that the invention is also working for single glass panel having a coating on it.

### Coating

At least one coating system is present on one interface of the multi-glazed window. This coating system generally uses a metal-based layer and infrared light is highly refracted by this type of layer. Such coating system is typically used to achieve a to a low-energy multi-glazed window.

In some embodiment, the coating system can be a heatable coating applied on the multi-glazed window to add a defrosting and/or a demisting function for example and/or to reduce the accumulation of heat in the interior of a building or vehicle or to keep the heat inside during cold periods for example. Although coating system are thin and mainly transparent to eyes.

Usually, the coating system is covering most of the surface of the interface of the multi-glazed window.

The coating system can be made of layers of different materials and at least one of these layers is electrically conductive. In some embodiments, for example in automotive windshields, the coating system can be electrically conductive over the majority of one major surface of the multi-glazed window. This can causes issues such as heated point if the portion to be decoating is not well designed.

A suitable coating system is for example, a conductive film. A suitable conductive film, is for example, a laminated film obtained by sequentially laminating a transparent dielectric, a metal film, and a transparent dielectric, ITO, fluorine-added tin oxide (FTO), or the like. A suitable metal film can be, for example, a film containing as a main component at least one selected from the group consisting of Ag, Au, Cu, and Al.

Such coating systems are low in reflectance for RF radiation meaning that RF radiation are mostly transmitted through the material. In contrast, high in reflectance for RF radiation means that RF radiation are mostly reflected on the surface of the material and/or absorbed by the material and the attenuation is at level of 20 decibels (dB) or more. Low in reflectance means an attenuation at level of 10 decibels (dB) or less. The coating system which is high in reflectance for RF radiation means that the coating system is non-transmitting to RF radiation. Typically, the coating system has an emissivity of not more than 0.4, preferably equals to or less than 0.2, in particular equals to or less than 0.1, equals to or less than 0.05 or even equals to or less than 0.04.

The coating system may comprise a metal based low emissive coating system. Such coating systems typically are a system of thin layers comprising one or more, for example two, three or four, functional layers based on an infrared radiation reflecting material and at least two dielectric coatings, wherein each functional layer is surrounded by dielectric coatings. The coating system of the present invention may in particular have an emissivity of at least 0.010. The functional layers are generally layers of silver with a thickness of some nanometers, mostly about 5 to 20 nm. The dielectric layers are generally transparent and made from one or more layers of metal oxides and/or nitrides. These different layers are deposited, for example, by means of vacuum deposition techniques such as magnetic field-assisted cathodic sputtering, more commonly referred to as “magnetron sputtering”. In addition to the dielectric layers, each functional layer may be protected by barrier layers or improved by deposition on a wetting layer.

Moreover, if the multi-glazed window presents two coating systems applied on two different interfaces, a first coating needs to be decoated before the second one. For example, the decoating device decoats a portion on the closest coating system and then decoats the second one. The focus point is adapted to be on the correct coating system. Preferably, to avoid to modify the decoating of the closest coating, the decoating device decoats a portion on the farthest coating system and then decoats the closest one. The needed power to decoat the farthest one is higher than the needed power to decoat the closest one and risks to degrade the decoated shape of the portion on the closest one if this one is done before the farthest coating.

Dimensions and shape of the decoated portion depend on the desire application.

The decoated portion can be a full decoated area meaning that the coating system is removed in this entire portion. But such full decoating removes thermal properties of the multi-glazed window.

Alternatively, to minimize the decoating time while keeping functionalities, such as thermal performances, of the coating system, the decoated portion comprises decoated segments creating zones where the coating system is still present. Decoated segments can have a width between 200 nm and 50 nm and preferably between 25 nm and 35 nm forming specific designs, such as grid.

Decoated designs can depend on wanted visual aspect, desired wavelength transparency for example.

The position of the decoated portion on the multi-glazed window depends on the application.

The apparatus or part of the apparatus can therefore be adapted to the dimension of the portion to be decoated and/or to the dimension of the window.

### Horizontal Bar

According to the invention, the apparatus comprises an horizontal system comprising an horizontal bar. The horizontal bar has a section measured along a plane defined by Y-axis and Z-axis and a length measured along the X-axis.

Preferably, the section has a general rectangular-shape and more preferably the section has a general square-shape.

In some preferred embodiments, to easily install elements such as suction means, a straight-toothed rack, a rail slider or alike, the horizontal bar has a metric T-slot profile. The horizontal bar can comprises a top T-slot on the top surface; the top surface being the surface having the highest values in the z-axis. The horizontal bar can comprises a bottom T-slot on the bottom surface; the bottom surface being the surface having the lowest values in the z-axis meaning the bottom surface is opposite to the top surface and the bottom surface faces the ground. The horizontal bar can comprises a back T-slot on the back surface; the back surface being the surface having the highest values in the Y-axis meaning the back surface is the surface facing a multi-glazed window when the apparatus is detachably fixed in front of the multi-glazed widow. The horizontal bar can comprises a front T-slot on the front surface; the front surface being the surface having the lowest values in the Y-axis meaning the front surface is opposite to the back surface.

It is understood that any other manner to install elements on the horizontal bar can be used such as drilled holes.

The length of the horizontal bar can depend on the specific application and/or use, such as 600 mm, 1200 mm, 1600 mm or any other acceptable lengths.

The section of the horizontal bar can depend on the specific application and/or use, for example a 40×40 mm or 45×45 mm or any other acceptable sections.

The horizontal bar is preferably made of extruded aluminium to reduce the weight.

### Suction Means

According to the invention, the horizontal system also comprise at least one suction means configured to detachably fix said configured to detachably fix said apparatus in front of said multi-glazed window, meaning that the suction means can be detachably fixed on an external interface of said multi-glazed window or on a surface next to the multi-glazed window with the suction means, such as a wall, a train body, frames or alike.

In some embodiments, the length of the horizontal bar is too long to support the weight of the apparatus, then several suctions means can be used to reduce length between two fixation point.

The apparatus can therefore be fixed on and detach from the in situ mounted multi-glazed window to achieve decoating at different locations.

The at least one suction means is firmly fixed to the horizontal bar.

The at least one suction means suction means preferably comprises a vacuum pad or a suction cup.

According to some preferred embodiments, to stabilize the horizontal bar, the suction means comprises two vacuum pads.

In some embodiments, to avoid buckling or bending od the horizontal bar, the suction means can comprises three vacuum pads.

In some embodiments, the apparatus can be mounted in any placed of an external interface of the multi-glazed window depending the area to be decoat.

In some other embodiments, to be very efficient and covering a large portion to be decoated., the apparatus can be mounted in front of the multi-glazed window via the at least one suction means attached to the structure around the multi-glazed window such as a wall, a car body, a train body or alike.

The horizontal bar is configured to be installed substantially horizontally to said multi-glazed window meaning that the horizontal bar is extending along the X-axis.

In preferred embodiments, the suction means is fixed to the back T-slot of the horizontal bar. In some other embodiments, the suction means can be fixed on the bottom T-slot.

### Decoating Unit

According to the present invention, the apparatus comprises a decoating unit. The decoating unit comprises a first motor and a pinion wheel driven by the first motor and designed to run on the straight-toothed rack.

The first motor is designed to activate the pinion wheel so that the pinion wheel can run on the straight-toothed rack to displace the decoating unit along the horizontal bar meaning that the decoating unit is moving along an axis and preferably along the X-axis.

### Decoating Device

The decoating unit also comprises a decoating device to decoat at least partially the coating system.

The decoating device includes a laser source that generates a laser beam configured to remove a portion of the coating system.

Preferably, said decoating device can comprise a lens array configured to focus said laser source at a focus distance.

In some embodiments, the decoating device can be further improved by comprising a focusing means to automatically or manually modify the focus distance.

### Straight-Toothed Rack

According to the invention, the horizontal system further comprises a straight-toothed rack.

In preferred embodiments, the straight-toothed rack is installed in the top T-slot of the horizontal bar.

### First Motor

The decoating device comprises a first motor. The first motor is configured to drive a pinion wheel that running on the straight-toothed rack.

According to the invention, the first motor is a servomotor or a stepped motor.

Preferably, the first motor has a low acceleration to minimize couplings in starting phases, for example an acceleration less than about 2 m/s² , or even less (ie about 0.5 m/s²).

The first motor can be powered by a cable 611 or directly via a battery or alike.

### Pinion Wheel

According to the invention, the decoating unit further comprises a pinion wheel driven by the first motor and running on the straight-toothed rack.

The pinion wheel can be made of any suitable material such as steel, stainless steel, synthetic material or alike.

The pinion wheel is preferably made of the same material than the material of the straight-toothed rack.

In some embodiments, the hardness of the teeth of the pinion, or the pinion itself if made of a single material, is equal to or less than the hardness of the teeth of the straight-toothed rack, or the straight-toothed rack itself if made of a single material.

### Rail Slider

To facilitate the displacement of the decoating unit along the horizontal bar, the horizontal system further comprises a rail slider.

The rail slider is preferably fixed into the front T-slot to easily mount the decoating unit on it with a single operator.

### Shuttle

To easily mount and unmount the decoating unit from the horizontal bar while displacing the decoating unit along the horizontal bar, the apparatus comprises a shuttle (43) configured to slide along the rail slider.

The decoating unit is attached (hung) to the horizontal bar by the slider element and is hung, meaning suspended, by the shuttle on the rail slider. That means that the pinion wheel and the straight-toothed rack are not configured to support the weight of the decoating unit but configured to displace the decoating unit along the horizontal bar via the first motor, the weight of the decoating unit is taken by the shuttle, the rail slider and the horizontal bar not by the pinion wheel and the straight-toothed rack

When the apparatus is mounted in front of a multi-glazed window, the weight of the apparatus is supported by the suction means and the weight of the decoating unit is supported by the shuttle and the rail slider.

In some embodiments, to decoat a larger area, the decoating unit can comprise a second motor configured to displace the decoating device substantially perpendicular to the horizontal bar. The decoating device is able to be displace along the X-axis via the first motor and along the Z-axis via the second motor meaning that the decoating device is able to displace along the plane P substantially parallel to the plane Pw, meaning substantially parallel to the interfaces of the multi-glazed window.

This invention allows to displace the decoating device from a first horizontal system to a second horizontal system to avoid to displace the whole apparatus. The handling is thus easy and lighter for an operator compared to other solutions.

In preferred embodiments, the decoating device can comprise an orientation means configured to control the direction of said laser beam. In this way, the orientation means can orientate the laser beam in order to minimize the time spent by the laser beam at a specific location of the coating system especially during acceleration and deceleration phases of the displacement of the decoating device displaced by said motors. The laser beam scans the portion to be decoated thanks to this orientation means faster than the displacement of the decoating device. Thus, the combination of the displacement of the decoating device and the orientation of the laser beam is able to rapidly decoat a coated portion of a coating system. The orientation of the laser beam permits to have substantially the same exposition time on the coating systems even during acceleration and deceleration phases of the motors. Preferably, the decoating device comprises a synchronization means configured to synchronize the direction of said laser source via said orientation means with the displacement of said decoating means. The synchronization means permits to minimize the overheat and the over-exposition of the laser beam on the coating system. Displacement on plane P of the decoating device and the orientation of the laser beam permits to accelerate the decoating time thanks to a synchronization between displacement and orientation. The decoating time can be about five time faster for the same shape and same size of decoating compared to apparatus without a synchronization means. This synchronization can depend on the shape of the decoating. In one embodiment according to the present invention, the decoating device is displaced to decoat a line and the orientation means orients the laser beam along the same direction than the lane to minimize the over-exposition. Said orientation means may comprise at least a rotatable mirror or a mirror using a galvanometer based motor, to provide a light and fast orientation of the laser beam and to control and manage such orientation.

Indeed, to work correctly, the laser source of a decoating system is positioned at a sufficient distance in the Y-axis from the window in order to avoid any degradation during the movements of the decoating device. Typically, the laser is positioned at a working distance of about 160 mm or 250 mm from the window.

In order to correctly decoat a coating system, the laser source must be precisely focused onto the targeted coating system. Therefore, the position of the coating system must be known with a precision at least three times smaller than the depth of field of the decoating device. The depth of field corresponds to the distance around the focal point of a focused laser beam where the laser beam diameter is considered constant. This distance depends greatly of the laser beam characteristics and the optics used for focusing said laser beam. Typically, the depth of field is around 0.5 mm, which means that the precision on the focus position of the decoating device should be around 0.1-0.2 mm.

Alternatively, to increase to quality of the decoating and to ensure a correct focusing of the laser beam, the apparatus can comprises an optical system configured to detect on which interface said coating system is localized and to estimate a distance between the decoating device and the detected interface; and a displacement means configured to control the position of said decoating device in the direction normal to the plane P.

Moreover, in a preferred embodiment, the apparatus further comprises some means designed for the decoating device to focus on the appropriate interface of the multi-glazed window to achieve the necessary decoating.

In some embodiments, said displacement device comprises a third motor and a displacement control unit, configured to control and displace said decoating device in the direction normal to the plane P; configured to displace said decoating device of a displacement distance equal to the difference between the estimated distance and a focus distance in order to focus said decoating device on said detected interface of at least one coating system.

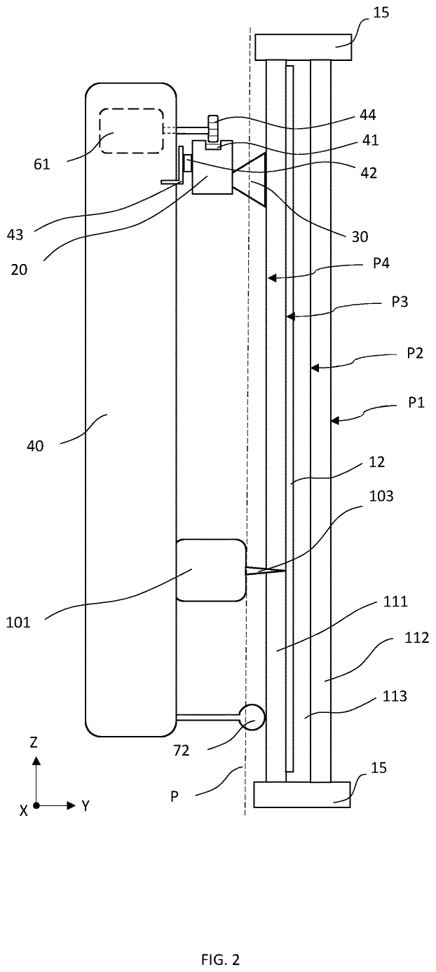

FIG. 2 illustrates a schematic sectional view according to plan AA′ of FIG. 1 of the apparatus 1 mounted on a multi-glazed window 11.

The multi-glazed window has two glass panels 111, 112 and a space 113 filled of gas. Said multi-glazed window has several interfaces P1, P2, P3, P4 and a coating system is present on the interface P3.

It is understood that the multi-glazed window can comprise more than two glass panels and/or more than one coating system.

The apparatus can also comprise a spacing mean 72 to maintain the decoating unit in the plane P parallel to interfaces.

As illustrated in FIG. 2, the horizontal system comprises an horizontal bar 20 and straight-toothed rack 41. The apparatus further comprises a slider 43. The decoating unit is suspended on the slider.

The decoating unit comprises a first motor 61 and a pinion wheel 44 driven by the first motor.

The decoating unit further comprises a decoating device 101 including a laser source that generates a laser beam 103. The laser beam can be focus to a focal point. This focal point correspond to the position of the coating system.

It is understood that the decoating device can be used to decoat a coating placed on any surface of the multi-glazed window.

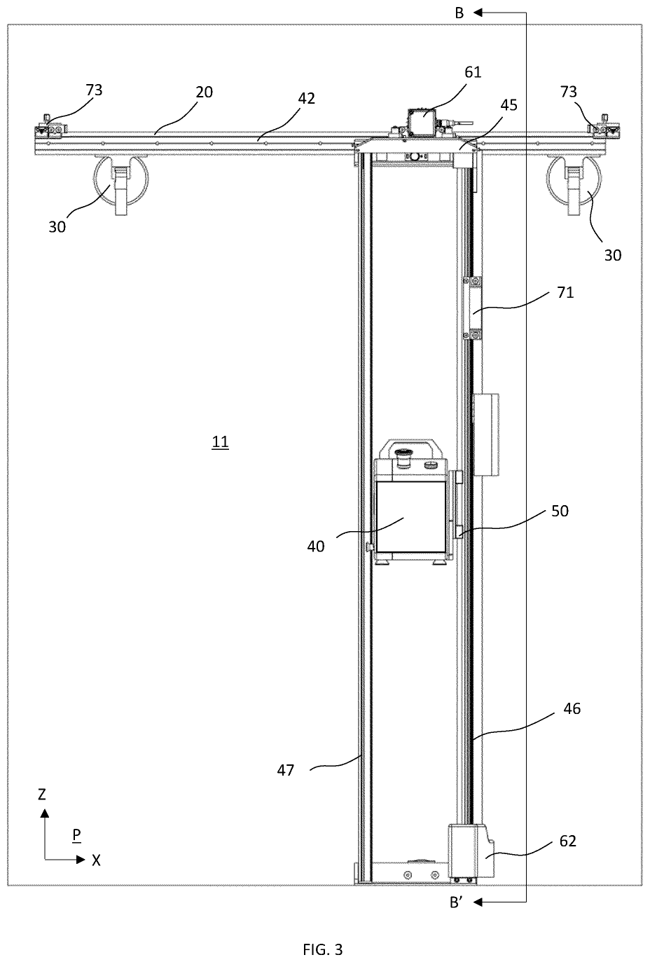

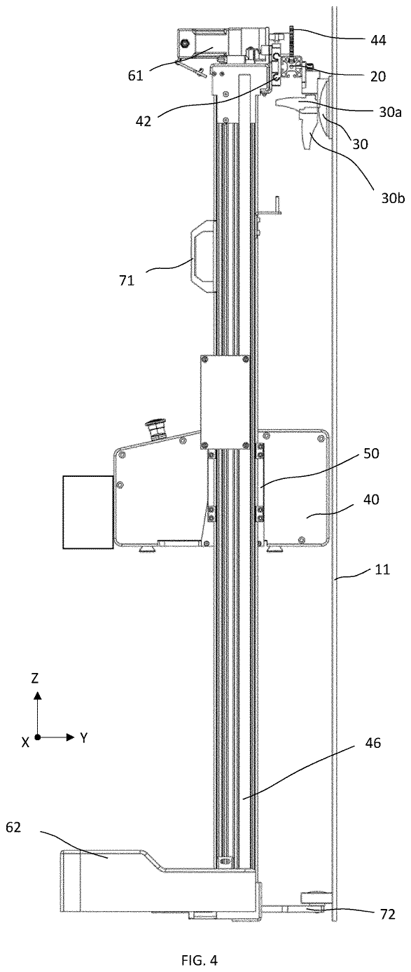

FIG. 3 and FIG. 4 illustrate an embodiment according to the present invention. In such embodiment, the apparatus for removing at least one portion of at least one coating system present in a multi-glazed window 11.

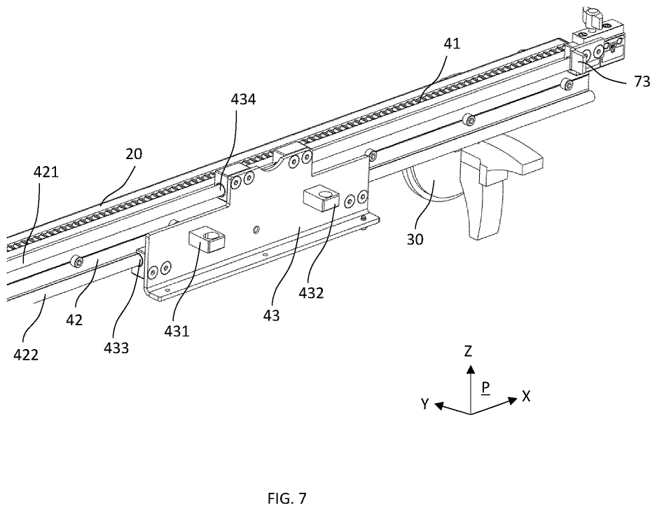

As illustrated more in details in FIG. 7, the apparatus of said embodiment comprises an horizontal system comprising an horizontal bar 20 with a metric T-slot profile and two suctions pads 30 as suction means configured to detachably fix said apparatus in front of said multi-glazed window, said suction means being firmly fixed to the horizontal bar via one T-slot profile, in the figures the one T-slot profile in front of the window. The suction means can comprise an activator, 30a, 30b to activate the suction function of the suction means; in one embodiment, the activator can have the shape of a leaver that can be bent from a position 30a to a position 30b where the suction function is activated.

In said embodiment, the horizontal system further comprises a straight-toothed rack 41 attached to a T-slot profile, in such figures, the top T-slot profile.

In said embodiment, the decoating unit comprises a top support 45, configured to be fixed to the shuttle and configured to hang the decoating unit on the shuttle, and a first vertical bar 46. The first vertical bar and the first motor 61 are fixed on the top support.

In said embodiment, the horizontal system further comprises and a rail slider 42 in a generic shape of a rail comprising two blisters 421, 422 on the top part and one on the bottom part of the rail slider.

In some embodiments, the horizonal system can comprises stoppers 73 to control the horizontal displacement, in X-axis, of the decoating unit and to stop the horizontal displacement without changing the dimension of the horizontal bar and/or changing the parameter of displacement.

In some embodiments, the horizontal system can have a locking means 431, 432 design to lock and to fix the decoating unit on the shuttle 43.

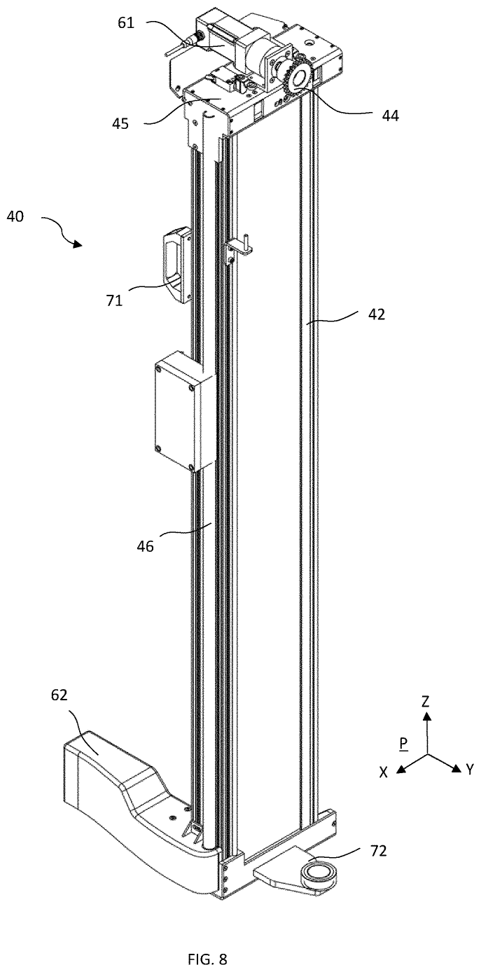

In the embodiment of FIG. 3 and FIG. 4 and more in details in FIG. 8, the apparatus also comprises a decoating unit 40 comprising a decoating device, hidden by a cover, including a laser source that generates a laser beam and a first motor 61. The decoating unit is displaced also thanks to a second motor 62.

### First Vertical Bar

To easily handle the decoating unit, the decoating device can comprises a handle 71 attached to the first vertical bar.

To stabilise the decoating unit and to guide the decoating device while easily handle the decoating unit, the decoating unit can comprise a second vertical bar 47. The second vertical bar is designed to guide the decoating device and/or the device support. The second vertical bar allows to reinforce the decoating unit while avoiding the vibration of the apparatus.

In some embodiments, the decoating device comprises a spacing means 72 designed to move, meaning slide, roll or alike, on the surface of the multi-glazed window.

This spacing means can be adapted to change the angle between the plane P and the surface of the multi-glazed window and/or to maintain parallelism between the area of the coating to be decoat.

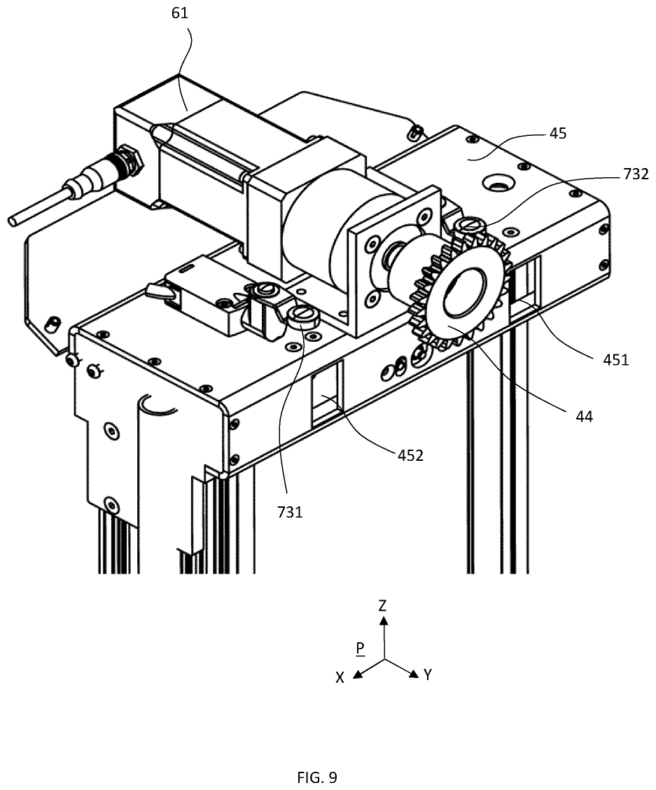

In the embodiment of FIG. 3 and FIG. 4 and more in details in FIG. 9, the apparatus comprises a shuttle 43 sliding along the rail slider. The slider is designed to slide along the rail slider, then in said embodiment, the slider comprises two channels 434, 433 cooperating with the corresponding two blisters 421, 422 to smoothly and directionally slide along the rail slider.

The decoating unit further comprises a pinion wheel 44 driven by the first motor and running on the straight-toothed rack.

The straight-toothed rack has a number of teeth depending on the length of the straight-toothed rack and the type of straight-toothed rack chosen. The pinion wheel is chosen for a specific diameter, called primitive diameter, and then the number of teeth is depending on this diameter. Smaller the diameter is, more precise the displacement is but also faster is.

In some embodiments, each of the first motor and/or the second motor can comprise a encoder to calculate the rotation to calculate the linear displacement. This encoder give a number of pulses per motor revolution, i.e. 1024 pulses/revolution. Then the displacement of the pinion wheel is Pi*(primitive diameter) and then, the displacement per pulse is Pi*(primitive diameter)/(number of pulse). Preferably, to minimize acceleration issue, the motor can comprise a reductor, with a reduction factor, to reduce the number of revolution of the pinion wheel compared to the number of motor revolution, then the displacement per pulse is the pro rata of the reduction factor (i.e. 10:1).

In some preferred embodiments, the displacement per pulse equals to or is smaller than the thickness of grid lines to decoat, more preferably, the displacement per pulse is two times smaller than the thickness of grid lines to decoat, even more preferably, the displacement per pulse is five time smaller than the thickness of grid lines to decoat (i.e; for a thickness of grid lines of 35 μm, the displacement per pulse is about 0.007 mm).

As illustrated in FIG. 9, this embodiments can comprises stopping elements 731, 732 cooperating with stoppers 73 to stop the motor when the decoating unit is arrived at the desired limit of the zone to decoat.

The decoating unit is designed to be attached to the horizontal bar by the slider element.

FIG. 9 shown a fixing means 452, 453 on which a locking means can be inserted as used in some embodiments.

The decoating unit also comprises a decoating device 40, a device support 50 designed to support the decoating device and a second motor 62. The decoating device is placed on the device support. The second motor is designed to displace the device support along the first vertical bar and preferably the second motor is configured to displace the decoating device substantially perpendicular to the horizontal bar. Thanks to the second motor, the decoating device can be displace along the Z-axis.

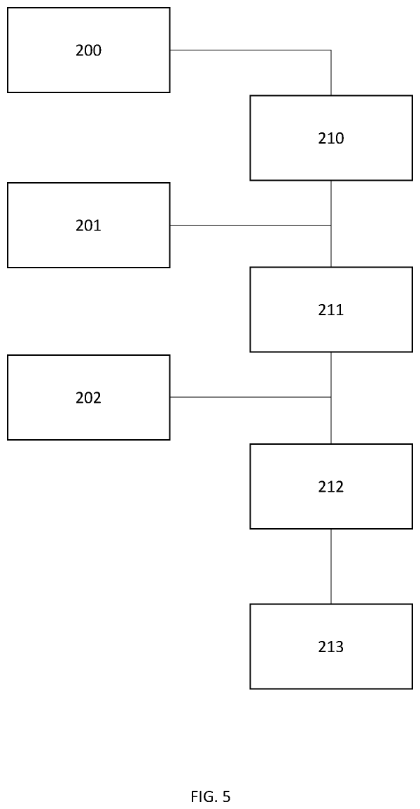

According to the second aspect of the present invention and as illustrated in FIG. 5, the present invention provides a method for removing at least one portion of at least one coating system 12 present in a multi-glazed window 11 with an apparatus 1 according to the first aspect of the present invention.

Said method comprises the following steps:
A1. Providing 200 the horizontal system;
A2. Mounting 210 the horizontal bar on an external interface P1 or P4 of said multi-glazed window with the suction means or mounting the horizontal bar on a surface of the object around the multi-glazed window the decoating device will be placed in front of the multi-glazed window;
A3. Providing (201) the decoating unit;
A4. Mounting (211) the decoating unit on the shuttle; the decoating unit is hanged on the shuttle;
A5. Providing (202) the decoating device;
A6. Mounting (212) the decoating device on the decoating unit;
A7. Removing (213) a first portion (13) of said coating system with said decoating device (101).

According to some preferred embodiments, step A3 and step A4 are respectively providing and mounting the decoating unit without the decoating device to facilitate the handling and the mounting step. The decoating device is mounted only on step A6.

In some other embodiments, step A3 and step A5 can be a single step as for step A4 and step A6.

After the decoating step A7, the apparatus can be displaced to a second multi-glazed window or stored to be transport to another location.

This method and the assembly of the apparatus of the present invention permit to a single operator to handle different parts of the apparatus alone. In fact, this operator can easily handle the horizontal system alone by mounting it at the desire location. Then when, the horizontal system is correctly installed, the operator can hang the decoating unit alone and after that place the decoating device. These different parts are light enough for such operator to handle, install and remove them by himself. On top of that, even if the access to the location is not easy, as the apparatus can be separated in several parts, the operator can bring them in any location.

To be able to store the apparatus, the present invention provides a method for removing at least one portion of at least one coating system present in a second multi-glazed window with an apparatus. Said method comprises the following steps:
B1. Unmounting 301 the decoating device of the decoating unit from the apparatus mounted on an external interface of a first multi-glazed window;
B2. Storing 302 the decoating device;
B3. Unmounting 303 the decoating unit from the shuttle;
B4. Storing 304 the decoating unit;
B5. Unmounting 305 the horizontal bar from the external interface of the first multi-glazed window;

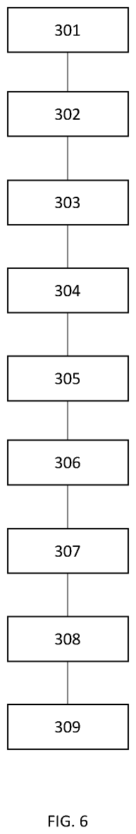

To be able to displace the apparatus to decoat a coating system present in a second multi-glazed window, according to the third aspect of the present invention and as illustrated in FIG. 6, the present invention provides a method for removing at least one portion of at least one coating system present in a second multi-glazed window with an apparatus.

Said method comprises the following steps:
B1. Unmounting 301 the decoating device of the decoating unit from the apparatus mounted on an external interface of a first multi-glazed window;
B2. Storing 302 the decoating device;
B3. Unmounting 303 the decoating unit from the shuttle;
B4. Storing 304 the decoating unit;
B5. Unmounting 305 the horizontal bar from the external interface of the first multi-glazed window;
B6. Mounting 306 the horizontal bar on an external interface of the second multi-glazed window with the suction means;
B7. Mounting 307 the decoating unit on the shuttle;
B8. Mounting 308 the decoating device on the decoating unit;
B9. Removing 309 a first portion of said coating system with said decoating device.

It is understood that said method can be used as many times as there are multi-glazed window to partially decoat.

Thanks to the enhanced apparatus, a different horizontal system can be already placed on different multi-glazed window and then only the decoating unit needs to be displace from an horizontal system to another one.

Preferably step A7 and/or step B9 are performed by orienting the laser bar with an orientation means, by displacing the decoating unit with the first motor and by displacing the decoating device with a second motor to remove a predetermined shape from said coating system.

More preferably, step A7 and/or step B9 are performed by synchronizing the displacement of the decoating unit and the orientation of the laser beam with a synchronisation means.

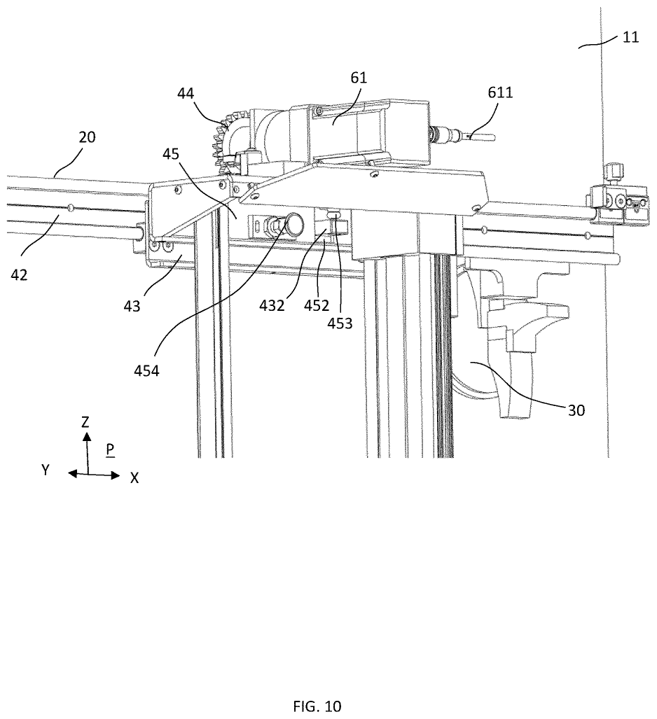

FIG. 10 illustrates more in details an embodiment of step A4, step B3 or step B7 of (un)mounting the decoating unit on (from) the shuttle.

In such embodiment, the horizontal system comprises locking means 432 collaborating with the decoating unit comprises a fixing means 452, 453.

The operator only has to lift the decoating unit without the decoating device (to reduce the weight) and hang it on the shuffle via the fixing means.

A locking system 454 can be added to lock the decoating unit on the shuttle.

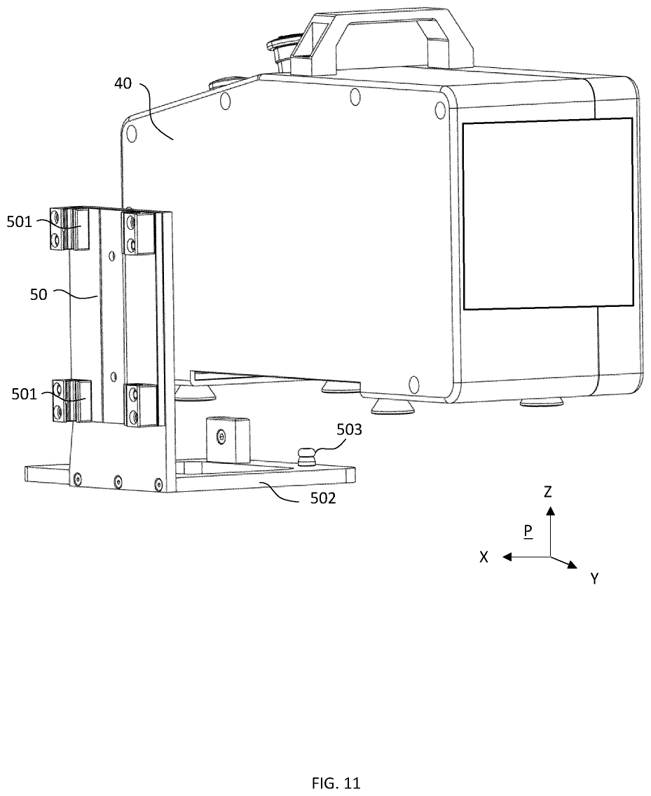

FIG. 11 illustrates step A6, step B1 or step B8 of (un)mounting the decoating device on (from) the decoating unit.

In preferred embodiments, the decoating unit comprises a device support 50 comprising support fixing means 501 to fix the device support on the first vertical bar and a support portion 502 supporting the decoating device 40. The support portion can comprises elements 503 to correctly position the decoating device on the device support while locking the decoating device on the device support.

In preferred embodiments, the decoating steps are to decoat partially the coating to create at least one frequency selective surface to form a communication window to let RF radiations passing thought the coating system and through the glazing unit depending on the grid parameters, such as distance between grid lines and shape of the grid mesh. The at least one frequency selective surface corresponds to a frequency selective decoated grid portion.

In the context of the invention, the term “decoated grid portion” includes a portion within the coating, which has, for example, linear decoating by a laser. The linear decoating forms a pattern with net meshes.

The linear decoating are visible in some incident angle due to the difference of colour between the decoating and the coating system.

The position and the dimension of the at least one frequency selective surface depend on the application.

The present invention provides the use of an apparatus according to the first aspect to remove at least one portion of at least one coating system present in a first multi-glazed window and to remove at least one portion of at least one coating system present in a second multi-glazed window wherein said second multi-glazed; said first multi-glazed window is mounted on a stationary object or on a mobile object and said second multi-glazed window is mounted on the stationary object or on the mobile object.

According to the invention, in different aspect of the invention, a single operator can handle parts of the apparatus, to mount, to unmount and to operate the decoating steps.

Thus, the present invention solves the need to fast decoat a multi-glazed window with a light and easy-to-handle apparatus and also solves the need to fast decoat several multi-glazed window placed in situ with an light and easy-to-handle apparatus.

1. An apparatus for removing at least one portion of at least one coating system present in a multi-glazed window, the window comprising at least two glass panels alternatively separated by at least one interlayer and forming multiple interfaces, the apparatus comprising:
an horizontal system comprising:
an horizontal bar and at least one suction means configured to detachably fix said apparatus in front of said multi-glazed window, said suction means being firmly fixed to the horizontal bar; and
a straight-toothed rack and a rail slider,
a decoating unit comprising:
a decoating device including a laser source that generates a laser beam;
a first motor; and
a pinion wheel driven by the first motor and running on the straight-toothed rack; and
a shuttle sliding along the rail slider, wherein the decoating unit is attached to the horizontal bar by the slider element.

2. The apparatus according to claim 1, the decoating unit further comprising a second motor configured to displace the decoating device substantially perpendicular to the horizontal bar.

3. The apparatus according to claim 1, the decoating device further comprising an orientation means configured to control a direction of said laser beam.

4. The apparatus according to claim 3, the decoating device further comprising a second motor and a synchronization means configured to synchronize a direction of the laser source via said orientation means with a displacement of the decoating means via the first and the second motors.

5. The apparatus according to claim 1, wherein the decoating device further comprises:
an optical system configured to detect on which interface the coating system is localized, and to estimate a distance between the decoating device and the detected interface; and
a displacement means configured to control a position of said decoating device in a direction normal to a plane P.

6. The apparatus according to claim 5, said displacement device further comprising a third motor and a displacement control unit, the displacement control unit:
configured to control and displace said decoating device in the direction normal to the plane P; and
configured to displace said decoating device a displacement distance equal to a difference between the estimated distance and a focus distance in order to focus said decoating device on said detected interface of at least one coating system.

7. The apparatus according to claim 1, the decoating device further comprising a top support and a first vertical bar
wherein the first vertical bar and the first motor are fixed on the top support.

8. The apparatus according to claim 7, the decoating unit further comprising a device support designed to support the decoating device
wherein the second motor displaces the device support along the first vertical bar.

9. The apparatus according to claim 7, the decoating unit further comprising a second vertical bar designed to guide the decoating device.

10. The apparatus according to claim 1, of wherein the decoating device further comprising a spacing means designed to move on a surface of the multi-glazed window.

11. A method for removing at least one portion of at least one coating system present in a multi-glazed window with an apparatus according to claim 1; said method comprising:
A1. Providing the horizontal system;
A2. Mounting the horizontal bar on an external interface of said multi-glazed window or on a surface next to the multi-glazed window with the suction means;
A3. Providing the decoating unit
A4. Mounting the decoating unit on the shuttle;
A5. Providing the decoating device;
A6. Mounting the decoating device on the decoating unit; and
A7. Removing a first portion of said coating system with said decoating device.

12. A method for removing at least one portion of at least one coating system present in a second multi-glazed window with an apparatus according to claim 1; said method comprising:
B1. Unmounting the decoating device of the decoating unit from the apparatus mounted on an external interface of a first multi-glazed window;
B2. Storing the decoating device;
B3. Unmounting the decoating unit from the shuttle;
B4. Storing the decoating unit;
B5. Unmounting the horizontal bar from the external interface of the first multi-glazed window;
B6. Mounting the horizontal bar on an external interface (P1, P4) of the second multi-glazed window with the suction means;
B7. Mounting the decoating unit on the shuttle;
B8. Mounting the decoating device on the decoating unit; and
B9. Removing a first portion of said coating system with said decoating device

13. (canceled)

14. (canceled)

15. (canceled)

16. The apparatus according to claim 1, wherein the at least one suction means comprises a vacuum pad or a suction cup.

17. The apparatus according to claim 3, wherein the orientation means comprises at least a rotatable mirror or a mirrors using a galvanometer based motor.
